(19) United States
(12) Patent Application Publication
(10) Pub. No.: US 2012/0164997 A1
(43) Pub. Date: Jun. 28, 2012

(54) SYSTEM AND METHOD FOR ORGANIZING EVENTS AND MEETINGS

(75) Inventor: Murali Ramanathan Iyer, Acton, MA (US)

(73) Assignee: ZEEPLANNER LLC, Acton, MA (US)

(21) Appl. No.: 13/330,024

(22) Filed: Dec. 19, 2011

Related U.S. Application Data
(60) Provisional application No. 61/426,650, filed on Dec. 23, 2010.

(51) Int. Cl. H04W 4/00

(52) U.S. Cl. 455/414.2

(57) ABSTRACT

A method and apparatus for organizing events. The method can include processing event information associated with an event, storing the event information, and transmitting participant information related to the event to computing devices associated with participating users. The apparatus can be used to communicate information regarding an event. If the apparatus is being used to organize an event, the apparatus can transmit event information associated with an event, and if the apparatus is being used to participate in an event, the apparatus can receive participant information related to the event.

### RELATED APPLICATION DATA

This application claims priority to U.S. Provisional Patent Application No. 61/426,650, filed Dec. 23, 2010, which is hereby incorporated by reference in its entirety.

### FIELD OF THE DISCLOSED EMBODIMENT

The disclosed embodiment relates to organizing events. More specifically, the disclosed embodiment relates to organizing events using phone numbers associated with event participants.

### BRIEF DESCRIPTION OF THE DRAWINGS

FIG. 1 is a diagram illustrating an exemplary system of the disclosed embodiment.

FIG. 2 is a flowchart illustrating an exemplary method of the disclosed embodiment.

FIG. 3 is a diagram illustrating how the exemplary method of FIG. 2 can be preferably implemented according to the disclosed embodiment.

FIG. 4 is a diagram illustrating an exemplary computing device of the disclosed embodiment.

While systems and methods are described herein by way of example and embodiments, those skilled in the art recognize that the systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Events are a convenient way for people to connect in a meaningful way. Some types of traditional events include, for example, gatherings, such as ceremony (i.e. a marriage), a competition (i.e. a sports competition), a convention (meeting), a happening (i.e. a performance or situation meant to be considered as art), a festival (e.g. a musical event), a media event (e.g. a happening that attracts coverage by mass media), a party, and a sporting event, among others. In the more recent computing age, events can also include events that occur using conference calls, video conferences, chat rooms, blogs, web site forums, and the like.

People can be included in events in a variety of ways. For example, a person can be invited to an event, learn of an event and ask to be a participant, register or subscribe to be notified of upcoming events, register or subscribe to be automatically included in upcoming events, and the like. People can also be members of a group that is included in an event, such as alumni to a school, employees of a company, and the like. Thus, a person can be a participant based on their individual characteristics or by virtue of the characteristics of a group in which they are a member.

When scheduling an event, an organizer faces many challenges. For example, the organizer traditionally has to manage event information such as budgeting, establishing dates and alternate dates, selecting and reserving the event site, acquiring permits, and coordinating transportation and parking Event planning can also include details such as developing a theme or motif for the event, arranging for speakers and alternate speakers, coordinating location support (such as electricity and other utilities), arranging decor, tables, chairs, tents, event support and security, catering, police, fire, portable toilets, parking, signage, emergency plans, health care professionals, and cleanup.

For obvious reasons, communication is key when organizing and scheduling an event, particularly when finding a suitable time for an event such as meeting, conference, trip, etc. For example, event scheduling should take into account what impact particular dates of the event could have on the success of the event. When organizing a scientific conference, for example, organizers might take into account the knowledge in which periods classes are held at universities, since it is expected that many potential participants are university professors. They should also try to check that no other similar conferences are held at the same time, because overlapping would make a problem for those participants who are interesting in attending all conferences.

When it is well known who is expected to attend the event (e.g. in the case of a project meeting), organizers usually try to synchronize the time of the event with planned schedules of all participants. This is a difficult task when there are many participants or when the participants are located at distant places. In such cases, the organizers should first define a set of suggested dates and address a query about suitable dates to potential participants. After response is obtained from all participants, the event time suitable for most of participants is selected.

The challenge of coordinating children's curricular and extracurricular activities, staying on top of requirements for each activity is no exception. As an example, a typical family of 2 children, say under the age of 16, on an average typically have at least one school related event (PTA, Field trip, projects etc) per week, with, on an average extra school activities such as sports, karate, arts etc events is about 2 per kid, with a few require lot more coordination with other parents in terms of pick ups and drop offs. The problem is further complex when the parents are divorced. Presently, the most prevalent way of coordinating such activities between organizers and parents are email based (even though every parent has a cell phone) simply because currently available calendaring solutions limit the scope to an email address.

This procedure can be alleviated by internet tools. However, traditional event scheduling is done using each participant's name or email address, as that was the only unique way to identify a participant for the purpose of scheduling. For example, existing calendaring systems allow a meeting organizer to invite participants using an email address that uniquely identifies participants in the email system that also serve as a scheduling system. For example, the Microsoft Exchange server limits scheduling of events and meetings to those users on its system. Though a meeting organizer could invite a participant that is currently not a user in that system, such a participant's schedule information will not be available to the organizer

The disclosed embodiment relates to scheduling and organizing events and meetings using mobile phone numbers associate with participants. By utilizing the unique identifying characteristics of a participant's mobile phone number to retrieve scheduling information, the disclosed embodiment enables the facilitation of meetings and events between any participants who can be uniquely identified using their mobile phone number. In essence, the disclosed embodiment extricates the tight association between email address and scheduling systems thereby making it more flexible. Thus, the disclosed embodiment provides a novel method and an associated platform that by way of identifying participants by their respective phone numbers, allows scheduling of events and meetings between one or more participants.

With the widespread use of mobile phones, the disclosed embodiment eliminates the need to uniquely identify a participant using an email address, and any participant with a mobile phone can thus be included in an event, regardless of whether each user has an email address or the like. The participants' phone numbers can be associated with any carrier, and by associating phone numbers with scheduling and organizing of events, there is no need for all participants to be on the same email server, etc. By associating phone numbers to calendaring/scheduling, the disclosed embodiment allows an organizer who can be associated/identified with a phone number to schedule events and meetings with one or more people who in turn can be identified/associated with a unique phone number. By including the telephone country calling code as part of the phone number, the disclosed embodiment can also be applied to events and meeting including global participants.

By way of providing scheduling and organizing events across anyone with a mobile phone number, and through mining the data of its user base, the disclosed embodiment paves way for promotion of products and services between businesses and its user base, with an opportunity to deliver promotions directly, in addition to other mechanisms such as email promotions, to mobile and tablet devices.

In addition, an organizer of a group event can create self-subscribing groups, such that people who want to be notified of scheduled activities for this group can follow the link sent by the group owner, and after providing the required information, join the group to receive notifications.

Overview of the Disclosed Embodiment

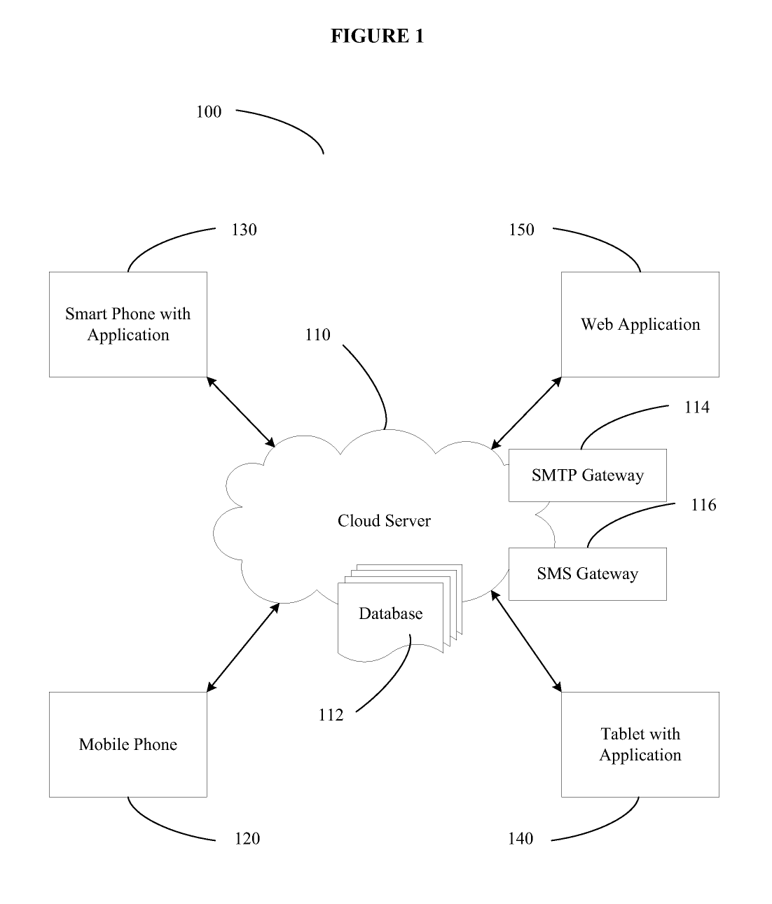

FIG. 1 is a diagram illustrating an exemplary system 100 of the disclosed embodiment. The system preferably includes a cloud server 110 which can communicate with smart phones 120, web applications 130, mobile phone 140, and the like. Each of these components will be described in more details below.

The Cloud Server

Cloud server 110 is a highly scalable, fully redundant system that is accessible over the internet. Primary functions of cloud server 110 include allowing users to create and maintain user accounts, receive account information from users, such as account names, phone numbers to be associated with the account name, privacy settings, visibility of scheduling information to other users, unique phone device information, such as IMEI (International Mobile Equipment Identity), type of device, etc., and any additional information, such as postal and email addresses, etc. Thus, to protect privacy, users on the system will be able to configure their profile/settings on whom else and how much can one see of one's calendar. Cloud server 110 is also capable of mining the demographic information of user data to offer product and services promotion. In addition, during operation, cloud server 110 can receive event information associated with an event and store the event information for future use.

When scheduling an event, it is preferred that the organizing user, or organizer, have an account stored in a database 112 on cloud server 110. If this is not the case, for example, if the organizer is a first-time user, the organizer may be provided with an option to create an account. Whenever participant(s) involved in a scheduled meeting/event do not yet have an account on cloud server 110, cloud server 110 would communicate with a computing device associated with the participant(s), for example, mobile phone 120, via SMS, to remind participant(s) of an upcoming event/meeting, with SMS reminders going out as per organizer's preference (for example, a day before the event/meeting followed by a multiple, variable minutes reminders prior to scheduled event), with an option for the recipient to cancel further reminders. The cloud server 110 can also be configured to offer an opportunity to anyone who does not want to receive SMS notifications, with functionality similar to that of a do-not-call list. Similarly, notifications to participants can be disabled, if needed.

Cloud server 110, by mining events data of its subscriber base, is also capable of offering suggestions on upcoming events, products, promotions that a user might be interested in. In addition, it can also offer such promotions, with direct delivery to the end user device such as mobile phones and tablet devices as one of the several delivery mechanisms. In the event an acceptance of a promotion requires addition of a reminder for the user, for example, an offer and subsequent acceptance to test drive a new mini van, the system is preferably capable of doing so.

Cloud server 110 can further provide programming interfaces for external applications to manage, schedule events and meetings, etc. over the internet. External applications may include, for example, applications that can be run on smart phones, such as smart phone 120, applications that can be run on tablets, such as tablet 140, and applications, for example, web application 150, that can be run using a web browser on any device having web access, such as computers, tablets, smart phones, and the like. Stand-alone calendaring applications may also be used to manage events through cloud server 110. Cloud server 110, either natively or by working with payment transaction providers, can also support payments between users in the system as needed.

To facilitate simultaneous sending of event details to mobile devices via SMS, etc. and email addresses, cloud server 110 further incorporates two gateway modules, an SMS gateway 116 for messaging (i.e. SMS and MMS) transmissions and a SMTP gateway 114 for email transmissions.

The Mobile Device Application

As indicated above, the disclosed embodiment preferably includes the use of mobile device applications run on a smart phone 130, a tablet 140, and the like. By installing the mobile device application on their device, a user can create an account on the system. Once an account is created the user on the system, the user can create and schedule events and meetings. While it is typically not required for a participant to have an account on the system, the organizer should have an account. The mobile device applications can be designed to run on various mobile and tablet platforms such as, but not limited, to Apple iOS platform, the Android platform, Blackberry platform, Palm OS, etc. These applications are capable of communicating with cloud server 110 to facilitate acceptance, rejection, and modifications associated with events and meetings. The mobile device applications preferably keep local calendars in sync with cloud server 110, while handling reminders locally as needed.

It should be noted that, to further ease the location and download of the mobile device applications from amongst several thousand applications available from sources such as an applications store, a link can be provided in any communication, such as an SMS message, thereby directing the user to an appropriate source to download the mobile device application. Any such link can also include an identifier that uniquely identifies a user on the system that triggered the communication that included the link, thereby facilitating a referral award, if desired.

The application are also preferably GPS aware (assuming that the device has the feature supported and enabled) and will take advantage of GPS location in sounding reminders for an upcoming event. For example, GPS can be used to dynamically and automatically adjust event notifications based on current location. For example, if an event was initially set for 12:00 PM EST, and, if the participant is currently in Chicago, USA, then the application on the device with GPS capabilities will sound the alarm for the upcoming event at 11:00 AM (current local time).

In addition, the applications can dynamically change how far ahead an alert needs to occur in order for the attendee to make the meeting on time. For example, if the invitee is in Acton, Mass., and if the meeting is in Boston Mass. at 11:00 AM, then based on certain historical and current travel times, the system may alert the user of impending event that takes into account the necessary travel time. In this case as an example, if the best estimated travel time from Acton, Mass. to Boston Mass. is 45 minutes, then the system will alert the user of an 11:00 AM EST meeting at 10:15 AM.

The mobile device applications will also provide various usability features such as labeling, tagging, and classifying of events and notifications such that the user can get a single unified view of one or more similar events. For example, if an event involves initiating a call to a participant, and if so desired, the device application can cause a mobile phone to automatically initiate a call to the participant phone number, there by alleviating the manual dialing of number to start the call/conference. For example, if the reminder is about calling mom on Sunday morning at 11:00 AM, then if such an option is chosen, the device will automatically initiate a call, at users preferred telephone number, to mom, for example, at 10:59 AM. The user of the device will also have the ability to record an audio and/or video message and send it to one or more groups. An exemplary situation where such an audio/video message would be useful is perhaps after a field trip the school teacher may want to broadcast to the parents updating them on the trip.

The mobile device application is further capable of receiving event notifications asynchronously. Optionally, the application can display details of a new event or changes to an existing event by taking partial or full control of the screen, as well as juxtaposition of event details over what the user is currently seeing on their screen. When a new event notification is displayed to the user, user is allowed to perform various actions, including but not limited to, snooze, ignore, remind again, cancel, etc.

Furthermore, when event notifications are received, the mobile device application allows users to classify the event (as sports, school, match club, etc). Optionally, it can also be classified by a person's name and color coded automatically. The application will further allow users of device to view local calendar activities in several different ways including but not limited to per activity class type, daily, weekly, per person, etc.

In addition, if so desired, the mobile device applications can operate with cloud server 110 to facilitate payments between users. An exemplary situation would be an organizer of a group activity may chose to be paid or for the purpose of splitting a dinner tab after enjoying a sumptuous meal with a group of friends.

The mobile device applications are also preferably capable of asynchronous reception of promotional messages and events with an option to accept or deny. If the user accepts the offer, the mobile device application can then guide the user to completion of purchase of product under the promotion. Information regarding where a participant is going to be, who each participants is, and what the event is about provides opportunities to offer pertinent and timely promotions relating to participant's areas of interest.

The Web Application

Using the interfaces provided by cloud server 110, a user on cloud server 110 could log into the server from any device that supports a web browser, such as Internet Explorer, Firefox, Safari, Google Chrome, etc. Using a web application interface, a user can initiate, manage events/calendars, update their profile, create and send event/meeting reminders even for large groups, compiled either from their contact address book or by manually entering or importing from a file, of participant phone numbers, and the like. The disclosed embodiment will further allow an account holder on the system to, from a single web page, initiate event related group messages destined for email addresses, SMS message and message for those with either the web application or the mobile device applications installed on their respective devices.

The web application also preferably facilitates finding the earliest available time for two or more people, help with automatic assignment of group activities to members of a group (for example help with scheduling a group of parents sharing car pooling activity, parent volunteer scheduling), etc. Thus, the platform of the disclosed embodiment, by using phone numbers of the organizer and participant as a key into their respective calendars', is capable of providing optional guidance on the next mutually best available time for scheduling an event/meeting. The organizing user can also make available multiple slots of time that are available to the group on a first come first served basis. The system will be able to display available slots. An application of this would be a teacher opening up 30 minute time slots for parents to meet with the teacher. In addition, if a user is identified as a business user, then the business can initiate a promotional event for a product or service targeting those based on the demographic information stored on cloud server 110.

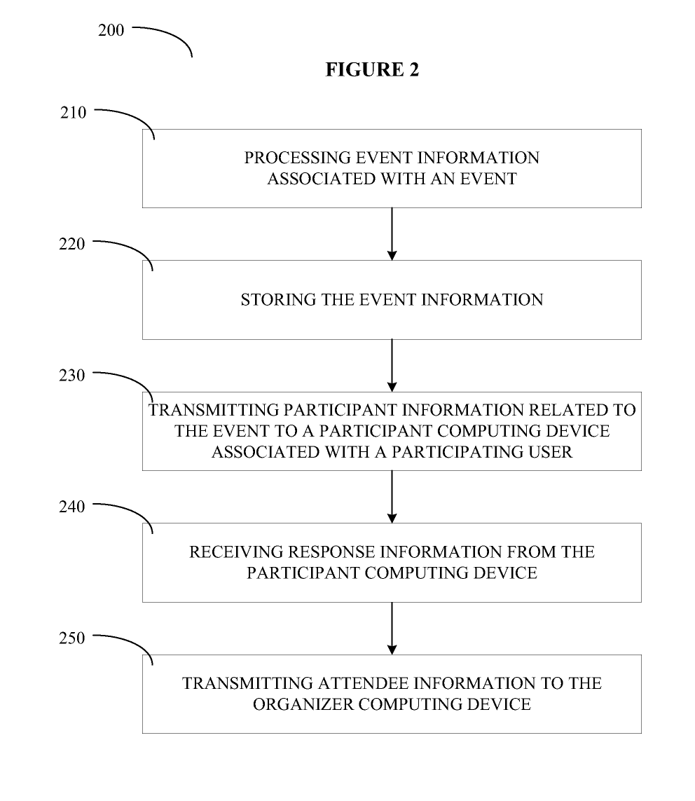

Using the components illustrated in FIG. 1 and described above, the disclosed embodiment further provides a method 200 for organizing an event, which is illustrated in FIG. 2. In step 210, event information associated with an event is processed. The event information can include information related to the scheduling of the event, the substantive content of the event, activities associated with the event, the location of the event, an organizing user of the event, reminders for the event, and the like. In addition, the event information can include information such as a specification of how many reminders per event and how far ahead should each reminder be. For example, a school may want to remind parents of an upcoming field trip a week ahead of scheduled trip, followed by the day before and the day of the trip. The event information can also specify one or more participating users. The event information can also include attachment, for example, an audio or video recording, which can be sent to all participants. The event information can come from a variety of sources including, for example, a smart phone 130 or tablet 140 via a mobile device application, a web browser via the web application 150, and the like. In this regard, it is common for the event information to be received from an organizer computing device associated with a user organizing the event or meeting. In this regard, the organizer can enter the event information using an organizer user interface on an organizer computing device, which is configured to receive input from the organizing user. In addition, event information can be imported from a variety of sources, such as a different calendar application, from account settings, etc. Furthermore, a group owner or originator of an event can modify an event after its creation directly from the device in which the application is installed, and group owners can initiate new events, add participants to the event from local phone contacts as well as by manually entering a phone number. In step 220, the event information can be stored in cloud server 110, or in any other suitable storage, such as a remote storage. In this regard, the event information can be associated with a user account for later use, if desired.

In step 230, participant information related to the event is transmitted to a participant computing device associated with a participating user. The participating computing device for at least one participating user is preferably a mobile computing device corresponding to a phone number associated with the participating user, such as a mobile phone or a smart phone. For at least this participating user, the participant information is preferably transmitted to the mobile computing device using the phone number associated with the participating user. Thus, for at least this participating user, the unique identifier associated with the participating user is a phone number.

In step 240, response information can be received from participant computing devices associated with any number of participating users. The response information preferably includes, for example, personal information associated with the participating user, device information corresponding to the participant computing device, and the like. In this manner, the system can identify when the user has either changed their client device such as mobile phones, tablets etc, such that it can optionally push all of the future events and meetings to any applications installed on that device, or, if desired, populate past events. A participant user interface can also be provided to participant computing devices, which are configured to receive input from participating users. Participating users can use this interface to enter their responses.

In step 250, attendee information can be transmitted back to the organizer computing device via cloud server 110. This attendee information preferably includes, for example, information specifying whether the participating user will be participating in the event, any comments associated with the event, and the like.

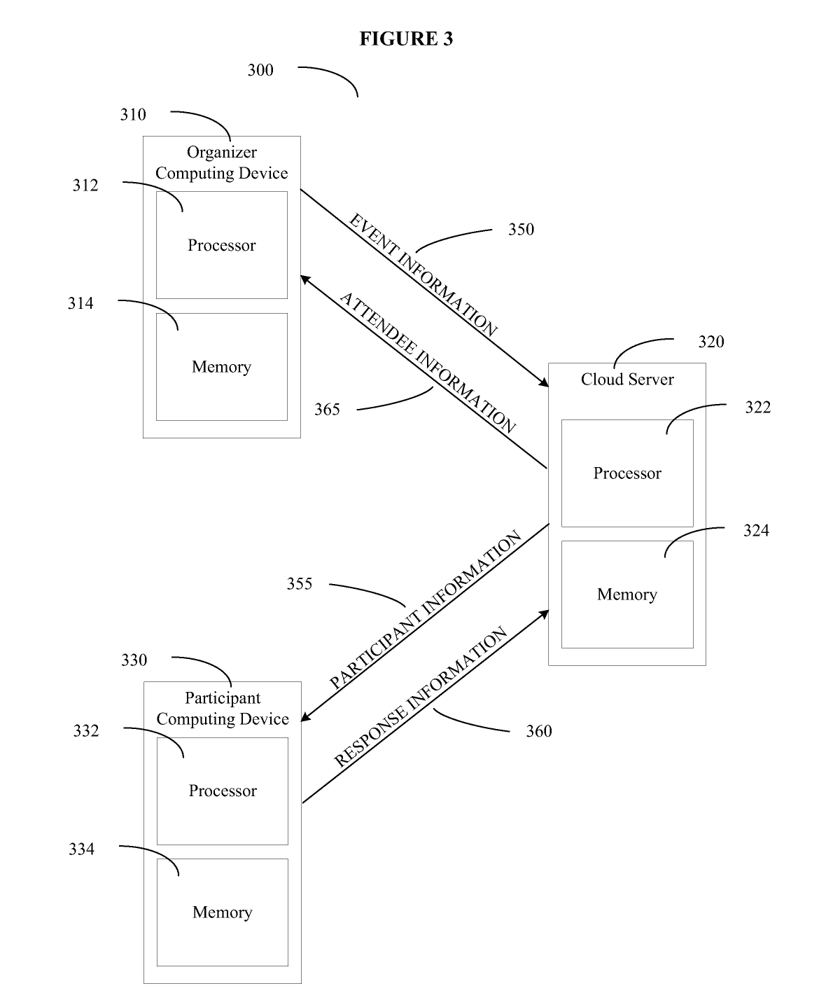

FIG. 3 shows a diagram 300 illustrating how the exemplary method of FIG. 2 can be preferably implemented. In FIG. 3, organizer computing device 310 includes a processor 312 and a memory 314. Memory 314 is preferably operatively coupled to processor 312, and contains instructions that, when executed by processor 312, cause processor 312 to carry out certain steps. Similarly, cloud server 320 includes a processor 322 and a memory 324. Memory 324 is preferably operatively coupled to processor 322, and contains instructions that, when executed by processor 322, cause processor 322 to carry out certain steps. Likewise, participant computing device 330 includes a processor 332 and a memory 334. Memory 334 is preferably operatively coupled to processor 332, and contains instructions that, when executed by processor 332, cause processor 332 to carry out certain steps.

During exemplary operation, organizer computing device 310, which is preferably associated with an organizing user, transmits event information associated with an event to cloud server 320, which in turn processes and stores the event information. In step 355, cloud server 320 transmits participant information related to the event to participant computing device 330, which is associated with a participating user, which in turn receives the participant information. It is preferred that participant computing device 330 is a mobile computing device corresponding to a phone number associated with the participating user, and that the participant information is transmitted to the mobile computing device using the phone number associated with the participating user. The participant information may include a link associated with the web or mobile device applications. If the application is installed, any existing events can be pushed to the application on participant user device 330. Pushing or updating events can also occur when there is any change to the event by the organizer

In step 360, participant computing device 330 transmits response information to cloud server 320, which in turn receives the response information. The response information preferably includes at least one of personal information associated with the participating user and device information corresponding to participant computing device 330. Finally, in step 365, cloud server 320 transmits attendee information to organizer computing device 310, which in turn receives the attendee information. The attendee information preferably includes information specifying whether the participating user associated with participant computing device 330 will be participating in the event.

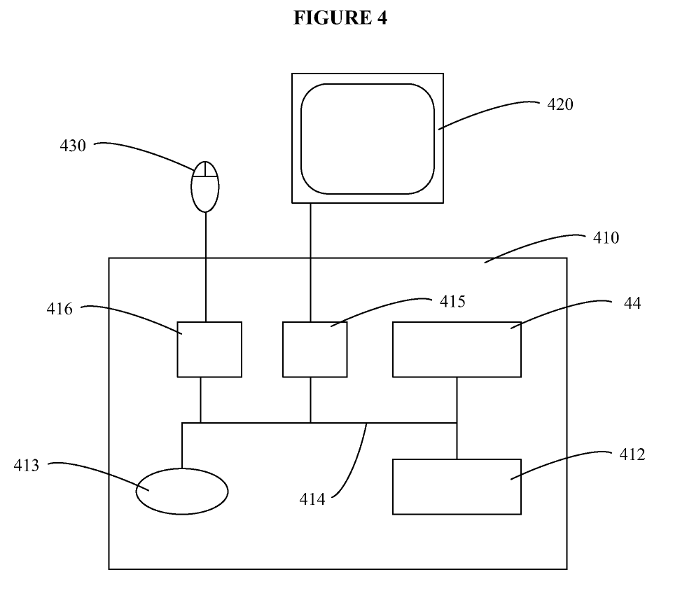

The embodiments described herein may be implemented with any suitable hardware and/or software configuration, including, for example, modules executed on computing devices such as computing device 410 of FIG. 4. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 410 has one or more processing device 411 designed to process instructions, for example computer readable instructions (i.e., code) stored on a storage device 413. By processing instructions, processing device 411 may perform the steps set forth in the methods described herein. Storage device 413 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 410 additionally has memory 412, an input controller 416, and an output controller 415. A bus 414 operatively couples components of computing device 410, including processor 411, memory 412, storage device 413, input controller 416, output controller 415, and any other devices (e.g., network controllers, sound controllers, etc.). Output controller 415 may be operatively coupled (e.g., via a wired or wireless connection) to a display device 420 (e.g., a monitor, television, mobile device screen, touch-display, etc.) In such a fashion that output controller 415 can transform the display on display device 420 (e.g., in response to modules executed). Input controller 416 may be operatively coupled (e.g., via a wired or wireless connection) to input device 430 (e.g., mouse, keyboard, touch-pad, scroll-ball, touch-display, etc.) In such a fashion that input can be received from a user (e.g., a user may input with an input device 430 a dig ticket).

Of course, FIG. 4 illustrates computing device 410, display device 420, and input device 430 as separate devices for ease of identification only. Computing device 410, display device 420, and input device 430 may be separate devices (e.g., a personal computer connected by wires to a monitor and mouse), may be integrated in a single device (e.g., a mobile device with a touch-display, such as a smart phone or a tablet), or any combination of devices (e.g., a computing device operatively coupled to a touch-screen display device, a plurality of computing devices attached to a single display device and input device, etc.). Computing device 410 may be one or more servers, for example a farm of networked servers, a clustered server environment, or a cloud network of computing devices.

While systems and methods are described herein by way of example and embodiments, those skilled in the art recognize that the systems and methods for organizing events are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for organizing an event, the method comprising:
processing, by a computing device, event information associated with an event;
storing, by a computing device, the event information; and
transmitting, by a computing device, participant information related to the event to a participant computing device associated with a participating user,
wherein the participant computing device is a mobile computing device corresponding to a phone number associated with the participating user, and
wherein the participant information is transmitted to the mobile computing device using the phone number associated with the participating user.

2. The method of claim 1, wherein the event information includes information related to at least one of the scheduling of the event, the substantive content of the event, activities associated with the event, the location of the event, an organizing user of the event, and reminders for the event.

3. The method of claim 1, wherein the event information specifies one or more participating users.

4. The method of claim 1, further comprising receiving response information from the participant computing device, wherein the response information includes at least one of personal information associated with the participating user and device information corresponding to the participant computing device.

5. The method of claim 1, wherein the event information is received from an organizer computing device associated with an organizing user.

6. The method of claim 5, further comprising transmitting attendee information to the organizer computing device, wherein the attendee information includes information specifying whether the participating user will be participating in the event.

7. The method of claim 5, further comprising providing an organizer user interface to the organizer computing device, the organizer user interface being configured to receive input from the organizing user.

8. The method of claim 1, further comprising providing a participant user interface to the participant computing device, the participant user interface being configured to receive input from the participating user.

9. An apparatus for organizing an event, the apparatus comprising:
a processor; and
a memory operatively coupled to the processor and containing instructions that, when executed by the processor, cause the processor to carry out the steps of:
processing, by a computing device, event information associated with an event;
storing, by a computing device, the event information; and
transmitting, by a computing device, participant information related to the event to a participant computing device associated with a participating user,
wherein the participant computing device is a mobile computing device corresponding to a phone number associated with the participating user, and
wherein the participant information is transmitted to the mobile computing device using the phone number associated with the participating user.

10. The apparatus of claim 9, wherein the event information includes information related to at least one of the scheduling of the event, the substantive content of the event, activities associated with the event, the location of the event, an organizing user of the event, and reminders for the event.

11. The apparatus of claim 9, wherein the event information specifies one or more participating users.

12. The apparatus of claim 9, wherein the instructions, when executed by the processor, cause the processor to carry out the further step of receiving response information from the participant computing device, wherein the response information includes at least one of personal information associated with the participating user and device information corresponding to the participant computing device.

13. The apparatus of claim 9, wherein the event information is received from an organizer computing device associated with an organizing user.

14. The apparatus of claim 13, wherein the instructions, when executed by the processor, cause the processor to carry out the further step of transmitting attendee information to the organizer computing device, wherein the attendee information includes information specifying whether the participating user will be participating in the event.

15. The apparatus of claim 13, wherein the instructions, when executed by the processor, cause the processor to carry out the further step of providing an organizer user interface to the organizer computing device, the organizer user interface being configured to receive input from the organizing user.

16. The apparatus of claim 9, wherein the instructions, when executed by the processor, cause the processor to carry out the further step of providing a participant user interface to the participant computing device, the participant user interface being configured to receive input from the participating user.

17. An apparatus for communicating information regarding an event, the apparatus comprising:
a processor; and
a memory operatively coupled to the processor and containing instructions that, when executed by the processor, cause the processor to carry out the steps of:
if the apparatus is being used to organize an event, transmitting event information associated with an event; and
if the apparatus is being used to participate in an event, receiving participant information related to the event, wherein the apparatus corresponds to a phone number associated with a participating user, and wherein the participant information is received via the phone number associated with the participating user.

18. The apparatus of claim 17, wherein the event information includes information related to at least one of the scheduling of the event, the substantive content of the event, activities associated with the event, the location of the event, an organizing user of the event, and reminders for the event.

19. The apparatus of claim 17, wherein the event information specifies one or more participating users.

20. The apparatus of claim 17, wherein the instructions, when executed by the processor, cause the processor to carry out the further step of transmitting, if the apparatus is being used to participate in an event, response information, wherein the response information includes at least one of personal information associated with the participating user and device information corresponding to the apparatus.

21. The apparatus of claim 17, wherein the instructions, when executed by the processor, cause the processor to carry out the further step of receiving, if the apparatus is being used to organize an event, attendee information, wherein the attendee information includes information specifying whether a participating user will be participating in the event.

22. The apparatus of claim 13, wherein the instructions, when executed by the processor, cause the processor to carry out the further step of receiving, if the apparatus is being used to organize an event, an organizer user interface, the organizer user interface being configured to receive input from an organizing user.

23. The apparatus of claim 13, wherein the instructions, when executed by the processor, cause the processor to carry out the further step of receiving, if the apparatus is being used to participate in an event, a participant user interface, the participant user interface being configured to receive input from the participating user.
